(19) United States
(12) Patent Application Publication
(10) Pub. No.: US 2009/0238924 A1
(43) Pub. Date: Sep. 24, 2009

(54) Method for Manufacturing a Decorative Pizza

(76) Inventor: Richard C. Lawhorn, Knoxville, TN (US)

Correspondence Address: PITTS AND BRITTIAN P C, P O BOX 51295, KNOXVILLE, TN, 37950-1295, US

(21) Appl. No.: 12/050,395

(22) Filed: Mar. 18, 2008

(51) Int. Cl. A23P 1/00

(52) U.S. Cl. 426/104

(57) ABSTRACT

Described is a method for manufacturing a pizza having a decorative contour. The method includes contouring a pizza dough such that the contour of the dough is substantially the decorative contour. The dough is formed to define a shoulder and a top surface, whereby the shoulder defines the contour of the dough and the contour of the top surface. Toppings are positioned at the top surface such that the toppings accent the decorative contour. The shoulder retains the toppings at the top surface. The dough and toppings are cooked, resulting in the pizza having the decorative contour.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention pertains to a method for manufacturing a pizza having a decorative contour.

2. Description of the Related Art

Pizza is a popular food among children and various casual social gatherings. A common goal when managing children and/or casual social gatherings is entertainment. More specifically, at feeding times, an amused child is more likely to eat than a child having a foul disposition. Additionally, at casual social gatherings, entertaining food makes the gathering more enjoyable. Consequently, there is a desire for a pizza having an entertaining or amusing characteristic.

One conventional pizza manufacturing method, disclosed in Errera, U.S. Pat. No. 6,990,892, includes forming ridges of crust on the surface of a conventionally shaped pizza to create a desired shape on the surface of the pizza, such as an animal. This conventional method is limited in that the contour of the resulting pizza is that of a conventional pizza. As a result, the shape on the surface of the pizza is not overtly noticeable. Another conventional pizza manufacturing method, disclosed in Feeley, U.S. Pat. No. 6,242,026, includes decorating a pizza using edible food products. This conventional method is also limited in that the contour of the resulting pizza is that of a conventional pizza. As a result, the shape on surface of the pizza is not overtly noticeable. Consequently, a method for manufacturing a pizza having a decorative contour is desired.

### BRIEF SUMMARY OF THE INVENTION

In accordance with the various features of the present invention there is provided a method for manufacturing a pizza having a decorative contour. The method includes flattening a pizza dough such that the pizza dough defines a top surface. The flattened pizza dough is contoured such that the contour of the pizza dough is substantially the decorative contour. The contoured pizza dough is formed such that the pizza dough defines a shoulder that defines the contour of the pizza dough and the contour of the top surface. Toppings are positioned at the top surface such that the toppings accent the decorative contour. The toppings are retained at the top surface by the shoulder. The pizza dough, including the toppings, is cooked, resulting in the pizza having the decorative contour.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates one embodiment of a pizza having a decorative contour manufactured in accordance with the various features of the present invention;

FIG. 2 illustrates a pizza dough flattened in accordance with the various features of the present invention;

FIG. 3 illustrates one embodiment of a contouring device used to contour the pizza dough of FIG. 2 in one embodiment of the present invention; and

FIG. 4 illustrates an alternate embodiment of the contouring device of FIG. 3.

FIG. 5 illustrates one embodiment of a pizza dough contoured in accordance with the decorative contour of FIG. 1.

### DETAILED DESCRIPTION OF THE INVENTION

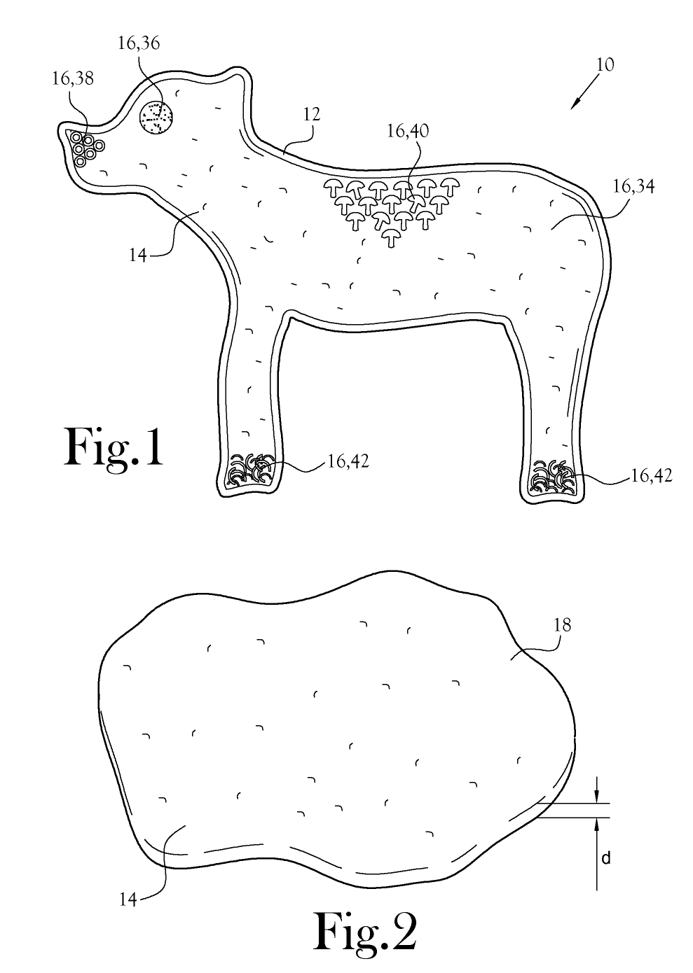

The present invention provides a method for manufacturing a pizza having a decorative contour. The method includes contouring a pizza dough such that the contour of the dough is substantially the decorative contour. The dough is formed to define a shoulder and a top surface, whereby the shoulder defines the contour of the dough and the contour of the top surface. Toppings are positioned at the top surface such that the toppings accent the decorative contour. The shoulder retains the toppings at the top surface. The dough and toppings are cooked, resulting in the pizza having the decorative contour. One embodiment of a pizza having the decorative contour manufactured in accordance with the various features of the present invention is illustrated generally at 10 in FIG. 1.

The pizza 10 defines a shoulder 12 and a top surface 14. The shoulder 12 establishes the perimeter of the pizza 10 and defines the contour of the pizza 10 and the contour of the top surface 14. The contour of the pizza 10 is a decorative contour. A decorative contour is any contour that is not conventional for a pizza, a conventional contour being a round or square contour. For example, in the illustrated embodiment, the decorative contour is that of an animal. The top surface 14 receives toppings 16 thereon, and the shoulder 12 retains the toppings 16 at the top surface 14. One step in manufacturing the pizza 10 is to flatten uncooked pizza dough such that the flattened dough 18 defines the top surface 14 and has a depth d, as illustrated at FIG. 2. The flattened dough 18 can be any dough suitable for creating a pizza crust. The depth d of the flattened dough 18 varies in accordance with the desired crust type and thickness of the resulting pizza 10.

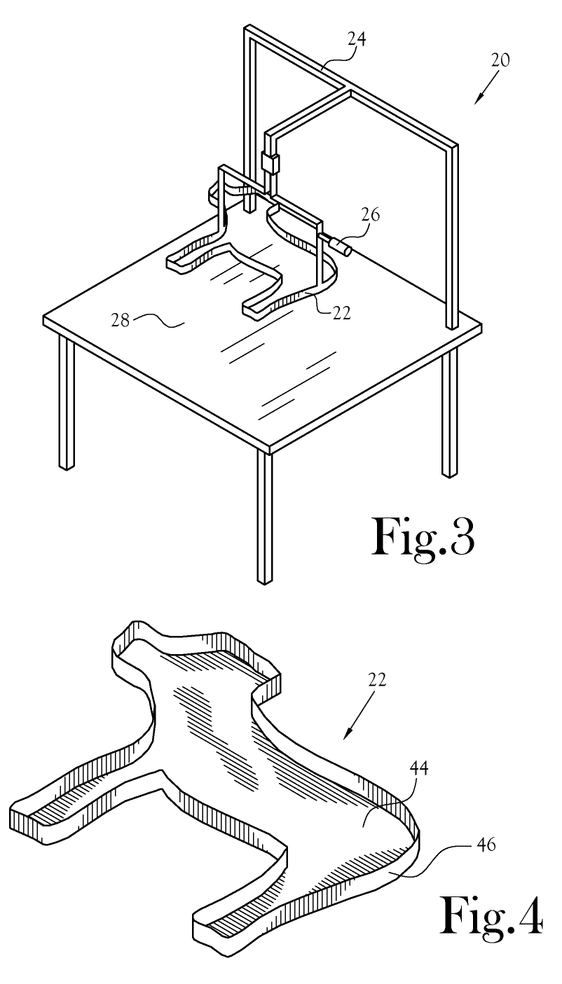

FIG. 3 illustrates a contouring device 20 in accordance with the various features of the present invention. The contouring device 20 contours the flattened dough 18 such that the contour of the flattened dough 18 is substantially the decorative contour. In the illustrated embodiment, the contouring device 20 includes a decorative contour template 22, a support structure 24, a handle 26, and a platform 28. Also, in the illustrated embodiment, the decorative contour template 22 is positioned above the platform 28 by the support structure 24. When positioned above the platform 28, the decorative contour template 22 is at a first position. The flattened dough 18 is positioned on the platform 28 directly below the decorative contour template 22. The decorative contour template 22 is moved from the first position to being in contact with the flattened dough 18. When in contact with the flattened dough 18, the decorative contour template 22 is at a second position. In the illustrated embodiment, the support structure 24 includes an extendable member 30 such that the decorative contour template 22 is movable between the first position and the second position. In one embodiment, the extendable member 30 is a spring-loaded device that biases the decorative contour template 22 to the first position but is movable, by some force, to the second position. In the illustrated embodiment, the decorative contour template 22 is movable between the first and second position by applying a manual force to the handle 26. It should be noted that the decorative contour template 22 can be moved between the first and second position by manual or motorized force without departing from the scope or spirit of the present invention. For example, in one embodiment, the decorative contour template 22 is moved between the first and second position by a motor activated by a manually operated switch. In another embodiment, the decorative contour template 22 is a hand-held device that is manually moved between the first and second position.

When at the second position, the decorative contour template 22 contours the flattened dough 18 such that the resulting contour of the flattened dough 18 is substantially the decorative contour. In the illustrated embodiment, when the decorative contour template 22 moves from the first position to the second position, the template 22 cuts the flattened dough 18, leaving the contoured dough 32 with a contour that is substantially the decorative contour.

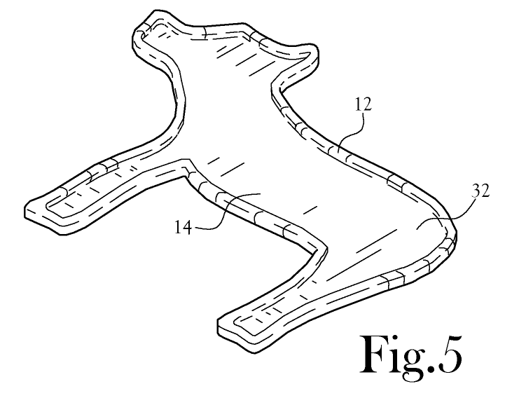

FIG. 4 illustrates an alternate embodiment of the decorative contour template 22 in accordance with the various features of the present invention. In the alternate embodiment, the decorative contour template 22 includes a bottom portion 44 a perimeter wall 46. The bottom portion 44 and the perimeter wall 46 define a pan-type structure that is constructed of a material cable of withstanding the conditions associated with baking a pizza. The perimeter wall 46 defines the contour of the decorative contour template 22, which is substantially the decorative contour. In one embodiment of the present invention, the alternate embodiment of the decorative contour template 22 contours the flattened dough 18 in accordance with the above discussion. More specifically, when at the first position, the bottom portion 44 of the decorative contour template 22 is away from the flattened dough 18. When moved to the second position, the perimeter wall 46 of the decorative contour template 22 contours the flattened dough 18 as discussed above. After contouring the flattened dough 18, the decorative contour template 22 is flipped such that contoured dough 32 is within the decorative contour template 22 to the extent that the contoured dough 32 is supported by the bottom portion 44 and contained by the perimeter wall 46.

In another embodiment of the above-discussed alternate embodiment of the decorative contour template 22, the flattened dough 18 is manually pressed into the decorative contour template 22 such that the dough is within the decorative contour template 22 as discussed above. When the dough is within the decorative contour template 22, the dough is contoured to the extent that it is the contoured dough 32.

FIG. 5 illustrates the contoured dough 32 corresponding to the pizza 10 of FIG. 1. The perimeter of the contoured dough 32 is formed to define the shoulder 12. In one embodiment, the shoulder 12 is formed by hand. The shoulder 12 defines the contour of the contoured dough 32 and the contour of the top surface 14. The shoulder 12 retains typical pizza toppings, such as sauce, cheese, pepperoni, etc., at the top surface 14. In one embodiment, the toppings 16 are positioned at the top surface 14 such that the toppings 16 accent the decorative contour. For example, in the illustrated embodiment of FIG. 1, the toppings 16 include cheese 34, a pepperoni 36, black olives 38, mushrooms 40, and onions 42. The cheese 34 is disposed at the top surface 14 such that the cheese 34 substantially covers the top surface 14 and appears to be the fur of the animal. The pepperoni 36 is disposed at the top surface 14 and at the head of the animal such that the pepperoni appears to be the animal's eye. The black olives 38 are disposed at the top surface 14 and at the head of the animal such that the black olives 38 appear to be the animal's nose. The mushrooms 40 are disposed at the top surface 14 and at the back of the animal such that the mushrooms 40 appear to be markings on the animal's fur. And the onions 42 are disposed at the top surface 14 and at the feet of the animal such that the onions 42 appear to be the animal's hooves.

When the contoured dough 32 has been formed to define the shoulder 12 and has been topped with the toppings 16, the contoured dough 32 is cooked. When the above-discussed alternate embodiment of the decorative contour template 22, which includes the bottom portion 44 and the perimeter wall 46, is used, the contoured dough 32 is cooked within the decorative contour template 22 such that the decorative contour template 22 maintains the contour of the contoured dough 32 through the step of cooking the contoured dough 32. In one embodiment, the contoured dough 32 is cooked in an oven. However, it should be noted that the contoured dough 32 can be cooked by ways other than using an oven, such as using a grill, without departing from the scope and spirit of the present invention. The cooked contoured dough 32 is the pizza 10 having the decorative contour. Although the decorative contour illustrated at FIG. 1 is that of an animal, it should be noted that the decorative contour can be a contour other than that of an animal without departing from the scope or spirit of the present invention. For example, the decorative contour can be that of a vehicle, or an article of sporting equipment, or a character, or a flower, or a crown. Accordingly, the toppings 16 can be positioned at the top surface 14 to accent the respective decorative contours as follows: when the decorative contour is that of a vehicle, pepperonis can be positioned to appear to be wheels; when the decorative contour is that of a football, peppers can be positioned to appear to be laces; when the decorative contour is that of a character, pepperonis can be positioned to appear to be facial features, such as eyes, a nose, and a mouth; when the decorative contour is that of a flower, pepperonis can be positioned to appear to be blooms; and when the decorative contour is that of a crown, pepperonis can be positioned to appear to be jewels.

From the foregoing description, those skilled in the art will recognize that a method for manufacturing a pizza offering advantages over the prior art has been provided. The method includes contouring a pizza dough such that the contour of the dough is substantially the decorative contour. The dough is formed to define a shoulder and a top surface, whereby the shoulder defines the contour of the dough and the contour of the top surface. Toppings are positioned at the top surface such that the toppings accent the decorative contour. The shoulder retains the toppings at the top surface. The dough and toppings are cooked, resulting in the pizza having the decorative contour.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A method for manufacturing a pizza having a decorative contour, said method comprising the steps of:
flattening a pizza dough such that the pizza dough defines a top surface and has a depth;
contouring the pizza dough such that the contour of the pizza dough is substantially the decorative contour;
forming the pizza dough such that the pizza dough defines a shoulder, the shoulder defining the contour of the pizza dough and the contour of the top surface, the shoulder being capable of retaining a topping at the top surface; and
cooking the pizza dough.

2. The method of claim 1 further comprising the step of positioning a topping at the top surface, the topping accenting the decorative contour.

3. The method of claim 1 wherein said step of contouring includes cutting the pizza dough such that the contour of the pizza dough is substantially the decorative contour.

4. The method of claim 3 wherein said step of contouring includes using a decorative contour template.

5. The method of claim 4 wherein the decorative contour template is manually operated.

6. The method of claim 4 wherein the decorative contour template is operated by way of a motor activated by a switch.

7. The method of claim 4 wherein said step of contouring includes positioning the pizza dough at a platform such that the pizza dough is positioned below the decorative contour template.

8. The method of claim 7 wherein the decorative contour template is moved by way of a manual force such that the decorative contour template contours the pizza dough.

9. The method of claim 7 wherein the decorative contour template is moved by way of a motorized force such that the decorative contour template contours the pizza dough.

10. The method of claim 4 wherein the decorative contour template includes a bottom portion and a perimeter wall, the decorative contour template being adapted to hold the pizza dough within the decorative contour template such that the pizza dough is supported by the bottom portion and contained by the perimeter wall.

11. The method of claim 10 wherein said step of contouring includes manually pressing the pizza dough into the decorative contour template such that the pizza dough is within the decorative contour template.

12. The method of claim 10 wherein said step of cooking includes cooking the pizza dough while the pizza dough is within the decorative contour template.

13. The method of claim 10 further comprising the step of flipping the decorative contour template such that the pizza is supported by the bottom portion and contained by the perimeter wall.

14. The method of claim 10 wherein said step of cooking includes cooking the pizza dough while the pizza dough is within the decorative contour template.

15. The method of claim 1 wherein the decorative contour is the contour of that of one selected from the group consisting of an animal, the head of an animal, an article of sporting equipment, a vehicle, a character, the head of a character, a flower, a crown, a jewel, a t-shirt, a shoe, and a building.

16. A method for manufacturing a pizza having a decorative contour, said method comprising the steps of:
contouring a pizza dough such that the contour of the pizza dough is substantially the decorative contour;
forming the pizza dough such that the pizza dough defines a shoulder and a top surface, the shoulder defining the contour of the pizza dough and the contour of the top surface, the shoulder adapted to retain a topping at the top surface; and
cooking the pizza dough.

17. The method of claim 16 further comprising the step of positioning a topping at the top surface such the topping accents the decorative contour.

18. The method of claim 17 wherein the topping further defines the decorative contour.

19. A method for manufacturing a pizza having a decorative contour, said method comprising the steps of:
flattening a pizza dough such that the pizza dough defines a top surface, the flattened pizza dough having a depth;
cutting the flattened pizza dough using a decorative contour template such that the contour of the cut pizza dough is substantially the decorative contour;
forming the cut pizza dough such that the pizza dough defines a shoulder, the shoulder defining the contour of the pizza dough, the shoulder defining the contour of the top surface;
positioning at least one topping at the top surface such that the at least one topping accents the decorative contour, the shoulder capable of retaining the at least one topping at the top surface; and
cooking the pizza dough and the at least one topping.

20. The method of claim 19 wherein the decorative contour template includes a bottom portion and a perimeter wall.

21. The method of claim 20 further comprising the step of flipping the decorative contour template such that the pizza dough is within the decorative contour template.

22. The method of claim 20 wherein said step of cooking includes cooking the pizza dough while the pizza dough is within the decorative contour template.
